(19) United States
(12) Patent Application Publication
(10) Pub. No.: US 2024/0344831 A1
(43) Pub. Date: Oct. 17, 2024

(54) METHOD FOR CONTROLLING PATH FOLLOWING BY A SELF-DRIVING LAND VEHICLE

(71) Applicant: YAPE S.R.L., Milano (MI) (IT)

(72) Inventors: Simone FIORENTI, Milano (MI) (IT); Davide FALCO, Vignate (MI) (IT); Francesco RICCIUTI, Roma (RM) (IT)

(73) Assignee: YAPE S.R.L., Milano (MI) (IT)

(21) Appl. No.: 18/579,703

(22) PCT Filed: Jul. 8, 2022
(86) PCT No.: PCT/IB2022/056337

§ 371 Date: Jan. 16, 2024

(30) Foreign Application Priority Data
Jul. 20, 2021 (IT) 102021000019109

(51) Int. Cl. G01C 21/30; G01C 21/34

(52) U.S. Cl. CPC G01C 21/30; G01C 21/3461; G01C 21/3469

(57) ABSTRACT

A self-propelled land vehicle to which the control method described herein applies includes a memory containing a map of territories, a microprocessor unit coupled to the memory and connected to a wireless communication network, a location sensor configured to provide the microprocessor unit with a geographical position signal of the self-propelled land vehicle, an electric motor to move the land vehicle and a battery for the electric motor. The memory contains a map with information on a connection quality parameter to the wireless communication network in correspondence with the territories, so that for each territory a corresponding value of the connection quality parameter in that territory can also be read in the map. The choice of the path is preferably made such that there is always a good connection to a wireless network.

### TECHNICAL FIELD

The present disclosure refers in general to a method of controlling the execution of a planned path by a self-propelled land vehicle, which can pass through environments in which the connection to a wireless communication network can be poor or even missing.

### BACKGROUND

Nowadays, self-propelled land vehicles are beginning to be developed for the automated delivery of small products, i.e. products that, for example, can have a size of about 50 cm×50 cm×50 cm and especially 42×38×31 cm.

These land vehicles are equipped with a compartment to house a package to be delivered or have a portion configured to fix the package itself thereto.

They are developed to navigate in a completely autonomous way thanks to path planning algorithms based on the information acquired by high-precision sensors, typically Lidars and video cameras.

To make a journey, self-propelled land vehicles need information about the environment in which they have to move, information that is typically incorporated into maps of environments (streets, sidewalks, cycle paths, pedestrian areas, etc.) that may be crossed, stored in a vehicle memory installed on board the land vehicles and functionally connected to the microprocessor units of the land vehicles themselves.

However, the maps provided to self-propelled land vehicles are not always up-to-date, for example because the characteristics of the environment can change over time.

### SUMMARY

One goal of this disclosure is to at least partially overcome the limitations of the approaches present in the state of the art. To this end, it is preferable that self-propelled land vehicles are always contactable via a wireless network even if they are equipped with a microprocessor unit configured to perform autonomous driving along a planned path, so that they can be driven remotely or recovered if lost or if no longer able to complete the established path.

Although wireless connection networks are increasingly widespread, it may happen that self-propelled land vehicles have to cross areas where the wireless connection is absent or poor because it is shielded, for example due to buildings or walls, and this can cause the loss of the vehicles themselves.

To limit the risk that self-propelled land vehicles may find themselves off a planned path, unable to continue and without a wireless connection to send a help request to a remote control center, a method for executing a path by a self-propelled self-driving land vehicle as defined in claim 1 has been devised.

Preferred embodiments are defined in the dependent claims.

### BRIEF DESCRIPTION OF THE DRAWINGS

FIG. 1 is a flowchart illustrating the control method of a self-driving land vehicle according to the present disclosure.

FIG. 2 shows a flow diagram of the steps of creating an augmented map, of the “augmented planning” of a path and of the execution of the path by the self-propelled land vehicle.

### DESCRIPTION OF EXAMPLE EMBODIMENTS

A self-propelled land vehicle to which the control method of the present disclosure applies comprises a memory containing a map of environments that may be crossed, at least one microprocessor unit functionally coupled to the memory and configured to connect to a wireless communication network when available, at least one location sensor functionally configured to provide said microprocessor unit with a geographical position signal of the self-propelled land vehicle, an electric motor configured to move the self-propelled land vehicle and at least one supply battery configured to power the electric motor. Like the self-driving land vehicles currently available, it is able to follow a path that allows to go from a starting point to an arrival point on the basis of a map of passable environments.

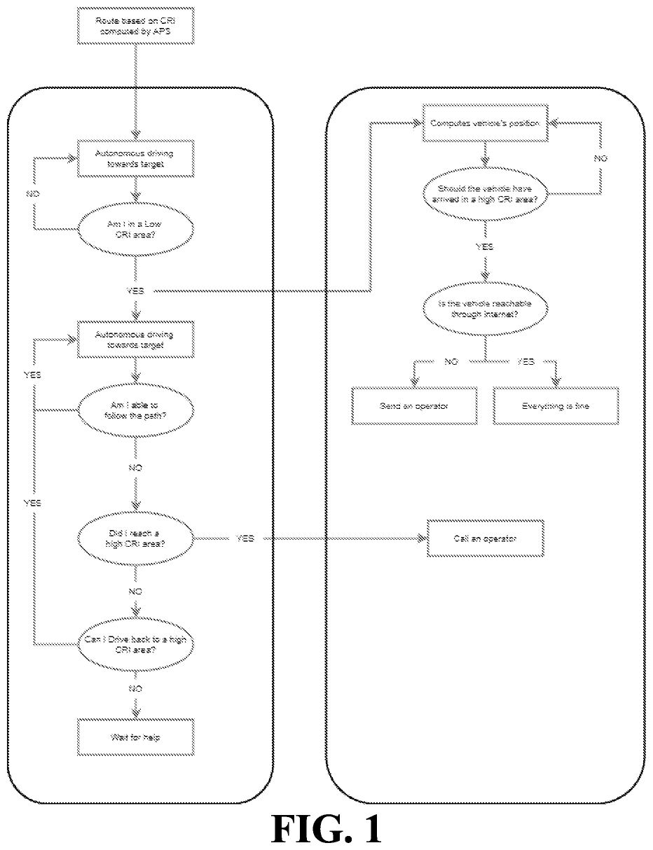

In the control method of the present disclosure, schematically depicted in FIG. 1, it is considered the case in which the memory contains an augmented map comprising a topographical map of the passable territories accompanied by information on a quality parameter (Connectivity Reliability Index—CRI) for connection to the wireless communication network in correspondence of the passable environments, so that for each passable environment a corresponding value of the connection quality parameter in that environment is also readable in the map. This quality parameter can be, for example, the power of the connection signal, or the availability of a 5G network, or more generally any other parameter indicative of the possibility of carrying out a valid wireless communication with a remote control unit at which it a human operator may be present. The augmented map also includes information on at least one characteristic of the territories chosen in the set consisting of a slope of the territories that the land vehicle could cross, a presence of holes and a presence of obstacles insurmountable by the land vehicle, such as for example too high steps, or muddy bottom, or barriers due to objects along the path, or even bottlenecks etc.

The path that the land vehicle can follow to move from a given starting point to a given arrival point is chosen on the basis of the augmented map. In other words, the path is not chosen only on the basis of the topographical map of the territories, but also on the basis of the additional information that accompanies the topographical map itself within the augmented map. According to one aspect, the choice of the path is preferably made in such a way that there is always a valid connection to a wireless network so as to be able to guarantee, at least in theory, the possibility of remotely guiding the self-propelled land vehicle if it is no longer able to follow the predetermined path or to give the self-propelled land vehicle the possibility to report its position if it is unable to continue due to a failure or an accident.

According to one aspect, the path that the land vehicle can follow is also chosen on the basis of an estimate of the energy required to complete the chosen path and on the basis of a detected charge level of the supply battery of the land vehicle.

According to one aspect, a planned path from a place of departure to a place of arrival is loaded into the memory of the self-propelled land vehicle. Alternatively, the place of departure and the place of arrival are indicated to the microprocessor unit and it is the microprocessor unit itself that identifies the planned path within the map loaded in memory, choosing it in order to avoid or minimize the crossing of territories with poor connection to the wireless network or with physical characteristics that cannot be traveled by the self-propelled vehicle or that require an energy consumption that exceeds the residual charge in the vehicle battery.

Once a path has been identified from the starting point to the arrival point, the self-propelled land vehicle performs an autonomous navigation algorithm to follow the identified path. During the autonomous navigation phase, the self-propelled land vehicle can be remotely monitored by an operator through a wireless communication network. However, the self-propelled land vehicle can also find itself in areas where there is not a good network coverage, so that contact can be lost with the remote control center that monitors it.

According to one aspect, during the autonomous navigation phase the self-propelled land vehicle will execute the algorithm illustrated in the flow chart of FIG. 1 every time it is in an area with poor wireless connection. If the self-propelled land vehicle loses the wireless connection but is still able to follow the previously established path, the microprocessor unit continues the autonomous navigation of the land vehicle, checking during its advancement whether the connection is re-established.

If the self-propelled land vehicle is unable to follow the predetermined path and the quality of the wireless connection does not allow the control of the land vehicle from the remote control unit, the microprocessor unit of the self-propelled land vehicle autonomously calculates a new path on the map, different from the predetermined path, to reach a passable environment with a good wireless connection and to be able to call an operator located in the remote control panel. At the same time, the microprocessor unit starts an internal timer and continues its autonomous navigation, checking during the advancement if the connection is re-established and if the time in which it remained without connection is still less than a predetermined maximum time. If the self-propelled land vehicle is unable to continue driving and continues to remain in areas with poor or no wireless connection and fails to reach an area with a connection within the set maximum time, the self-propelled land vehicle stops on the spot and remains awaiting intervention.

From the operator's side in the remote control unit that monitors the travel of the self-propelled land vehicle, when the self-propelled land vehicle is in an environment with low wireless connection, it is checked which path the self-propelled land vehicle may have recalculated and it is evaluated periodically if the vehicle may have reached an environment with a good wireless connection: if it is established that the self-propelled land vehicle should have already arrived in an environment with good wireless network coverage but it is not possible to reach the self-propelled land vehicle via wireless network, an alarm signal is generated to send an operator to retrieve the self-propelled land vehicle.

If, on the other hand, the self-propelled land vehicle has reached an environment with a good wireless connection, then contact is re-established to control it remotely, or to obtain its position, or to perform other operations in order to control it towards the place of arrival or other destination.

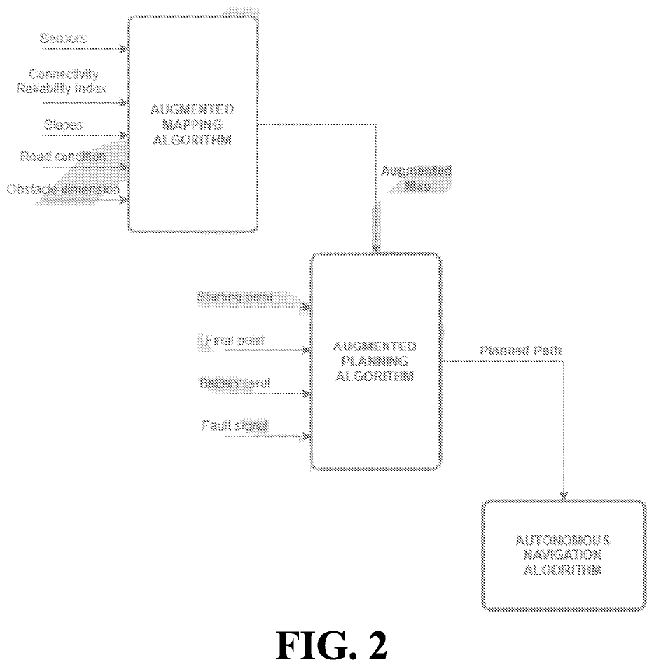

The territories to be traveled may have unexpected obstacles to be bypassed, or holes, or there may be roads theoretically passable by the land vehicle but with slopes not marked on the augmented map available to the vehicle itself. According to an aspect of this disclosure illustrated in the flow diagram of FIG. 2, the land vehicle continuously detects environmental characteristics, such as the presence of uphill roads, conditions of the road ahead (such as the presence of bumpy, muddy ground, etc.), any obstacles (for example steps, objects that obstruct the passage), as well as the presence of a wireless connection network. All these characteristics are detected by sensors installed on board the land vehicle, such as cameras, LiDAR sensors, wireless communication network presence sensors, etc. Thanks to this information, the augmented map originally made available to the land vehicle, containing at least the topographical map of the territories that can be traveled, are enriched with further information on the current conditions of these territories and which can influence the choice of the path to reach the predetermined destination. The augmented map (FIG. 2) is thus continuously enriched while the land vehicle is moving or, if only a topographical map of the passable territories is available, an augmented map is generated which includes both information on the oriented graph of the theoretically passable territories (topographic map) and information on the conditions that can affect the effective practicability of the territories themselves, such as the slope of the territories, the possible presence of holes and/or obstacles insurmountable by the land vehicle.

According to an aspect of the present disclosure, the microprocessor unit of the self-propelled vehicle performs a phase of planning the journey from the selected starting point to the arrival point using the augmented map, i.e. using both the topographical map of the theoretically practicable territories, and the information collected by sensors during trips made in the past on the characteristics of the territories themselves. In this case, when the microprocessor unit of the self-propelled vehicle has to plan the journey that it will have to perform autonomously, it will execute an “augmented planning” algorithm in which it is based on the augmented map and also takes into account the charge level of the land vehicle's batteries, to determine if the self-propelled land vehicle is able to travel the entire path before the batteries are completely discharged.

Thanks to the illustrated control method, the risk of losing the self-propelled land vehicle due to lack of network coverage on the predetermined path is minimized. In fact, in this circumstance, either the self-propelled land vehicle continues autonomously towards the final destination if it is able to do so, or it deviates from the predetermined path in order to reach an area with better wireless coverage, or it stops after a maximum time if it cannot reach that area. In this way, even if the position of the lost self-propelled land vehicle is not exactly known, a human operator may be able to identify a search area with a relatively small radius in which to search for it.

The present invention has so far been described with reference to preferred embodiments. It is understood that there could be other embodiments which refer to the same inventive concept defined by the scope of the following claims.

1. A method of controlling path following by a self-driving land vehicle, wherein said land vehicle comprises a memory containing an augmented map of territories that can be crossed by the land vehicle, a microprocessor unit functionally coupled to the memory and configured to connect to a wireless communication network when available, in which said augmented map comprises a topographical map of the territories accompanied by information on a connection quality parameter to said wireless communication network in correspondence with said territories and information on a characteristic of said territories chosen in the set composed of a slope of said territories and a presence of obstacles insurmountable by the land vehicle, a location sensor functionally configured to provide said microprocessor unit with a signal of the geographical position of the land vehicle, an electric motor configured to move the land vehicle and a supply battery configured to power the electric motor, said method comprising the following operations:
storing in said memory information of a planned path that said land vehicle must follow from a place of departure to a place of arrival identified on said map;
choosing with said microprocessor unit a path that the land vehicle can follow to move from a given starting point to a given arrival point on the basis of said augmented map, on the basis of an estimate of the energy required to complete the chosen path and on the basis of a detected charge level of the land vehicle supply battery;
performing with said microprocessor unit an autonomous navigation procedure from the place of departure to the place of arrival, comprising the following operations:
a) during the autonomous navigation of the land vehicle along the planned path, checking with said microprocessor unit if the land vehicle is in an area in which said connection quality parameter to the wireless communication network is less than a minimum value;
b) if the connection quality parameter to the wireless communication network is less than the minimum value, checking with said microprocessor unit if it is possible to continue autonomously along the planned path and repeating the operation a);
c) if the connection quality parameter to the wireless communication network is less than the minimum value and at the same time said microprocessor unit determines that the land vehicle can no longer continue along the planned path, choose a new, different path with said microprocessor unit from said planned path, which the land vehicle can follow to reach a first environment in said map in which said connection quality parameter exceeds the minimum value;
d) if the land vehicle reaches said first environment following the new path in less time than a predetermined maximum time starting from the moment it was determined that the land vehicle could not follow the planned path, sending a request for help to a remote control center through said wireless communication network; if, on the other hand, the land vehicle does not reach said first environment in said maximum predetermined time, stopping the land vehicle when said maximum predetermined time has elapsed starting from the moment when it was determined that the land vehicle could not follow the planned path.

2. The method according to claim 1, comprising the operations of:
if the connection quality parameter of the land vehicle to the wireless communication network is less than the minimum value, carrying out the following operations at the remote control center:
determining a position of the land vehicle;
determining said new path that the control unit of the land vehicle would choose to reach said first environment of the new path in which said connection quality parameter is greater than the minimum value;
if, from the moment in which the connection quality parameter of the land vehicle to the wireless communication network has become less than the minimum value, sufficient time has elapsed to allow the land vehicle to reach said first environment, checking whether the microprocessor control can be contacted via the wireless connection network or, in the opposite case, generating an alarm signal to send an operator to retrieve the land vehicle.

3. The method according to claim 1, in which sensors selected from the set consisting of cameras, LiDAR sensors and wireless communication network presence sensors are installed on board the land vehicle, said method further comprising the operation of detecting characteristics of an environment in which the land vehicle is located, carried out by means of said sensors installed on board the land vehicle, said characteristics including a slope of said territories and the presence of obstacles which cannot be overcome by the land vehicle.

4. The method according to claim 1, further comprising the operation of generating with said microprocessor unit the planned path that the land vehicle must follow from the place of departure to the place of arrival identified on the map.
